(19) United States
(12) Patent Application Publication
(10) Pub. No.: US 2014/0188927 A1
(43) Pub. Date: Jul. 3, 2014

(54) PRESENTING RECOMMENDED CONTENT IN SEARCH PAGES

(71) Applicant: Google Inc., (US)

(72) Inventors: Emily K. Moxley, San Francisco, CA (US); Sean Liu, El Dorado Hills, CA (US); Doug Sherrets, San Francisco, CA (US); Max Ventilla, San Francisco, CA (US)

(73) Assignee: Google Inc., Mountain View, CA (US)

(21) Appl. No.: 13/729,341

(22) Filed: Dec. 28, 2012

(51) Int. Cl. G06F 17/30

(52) U.S. Cl. CPC G06F 17/30864
USPC 707/769

(57) ABSTRACT

Methods, systems, and apparatus, including computer programs encoded on a computer storage medium include actions of receiving a search query, the search query being received from a first user of a computer-implemented search service, receiving a search result that is responsive to the search query, the search result being representative of one or more resources, receiving a set of entities associated with the one or more resources, receiving a first set of entities associated with the first user, each entity in the first set of entities having been determined to be of interest to the first user, determining that one or more entities of the set of entities corresponds to one or more entities of the first set of entities and, in response, providing a first set of recommended content, the first set of recommended content comprising the one or more entities of the set of entities, providing a first search results page, the first search results page comprising the search result and digital content representative of recommended content provided in the first set of recommended content, the digital content providing a link to a resource of the one or more resources, and transmitting the first search results page for display to the first user.

### BACKGROUND

This specification relates to displaying search results.

The Internet provides access to a wide variety of resources, such as image files, audio files, video files, and web pages. A search system can identify resources in response to queries submitted by users and provide information about the resources in a manner that is useful to the users. The users then navigate through (e.g., click on) the search results to acquire information of interest to the users.

Users of search systems are often searching for information regarding a specific entity. For example, users may want to learn about a singer that they just heard on the radio. Conventionally, the user would initiate a search for the singer and select from a list of search results determined to be relevant to the singer.

### SUMMARY

Implementations of the present disclosure are generally directed to a system and method for presenting a user with recommended content on search pages based on one or more of user interests and external trends.

In general, innovative aspects of the subject matter described in this specification can be embodied in methods that include actions of receiving a search query, the search query being received from a first user of a computer-implemented search service, receiving a search result that is responsive to the search query, the search result being representative of one or more resources, receiving a set of entities associated with the one or more resources, receiving a first set of entities associated with the first user, each entity in the first set of entities having been determined to be of interest to the first user, determining that one or more entities of the set of entities corresponds to one or more entities of the first set of entities and, in response, providing a first set of recommended content, the first set of recommended content comprising the one or more entities of the set of entities, providing a first search results page, the first search results page comprising the search result and digital content representative of recommended content provided in the first set of recommended content, the digital content providing a link to a resource of the one or more resources, and transmitting the first search results page for display to the first user. Other implementations of this aspect include corresponding systems, apparatus, and computer programs, configured to perform the actions of the methods, encoded on computer storage devices.

These and other implementations can each optionally include one or more of the following features: actions further include: receiving a set of trending entities, each entity in the set of trending entities having been determined to be of interest to users, and determining that one or more entities of the set of entities corresponds to one or more entities of the set of trending entities and, in response, including the one or more entities of the set of trending entities in the first set of recommended content; actions further include: receiving the search query, the search query being received from a second user of a computer-implemented search service, receiving the search result that is responsive to the search query, receiving the set of entities associated with the one or more resources, receiving a second set of entities associated with the second user, the second set of entities including at least one entity that had been determined to be of interest to the second user, determining that one or more entities of the set of entities corresponds to one or more entities of the second set of entities and, in response, providing a second set of recommended content, the second set of recommended content including the one or more entities of the second set of entities, providing a second search results page, the second search results page including the search result and digital content representative of recommended content provided in the second set of recommended content, the digital content providing a link to a resource of the one or more resources, and transmitting the second search results page for display to the second user; at least a portion of the recommended content in the first set of recommended content is different than recommended content in the second set of recommended content; the digital content is representative of categories of entities; actions further include determining that an intent of the first user comprises a navigational intent based on the search query, and in response: requesting the set of entities associated with the one or more resources, and requesting the first set of entities associated with the first user; actions further include providing the set of recommended content as a sub-set of a super-set of recommended content; recommended content of the super-set of recommended content is selectively included in set of recommended content based on respective relevance scores; the digital content includes thumbnail images and text associated with one or more web pages of a web site, the search result being representative of the web site; and determining that one or more entities of the set of entities corresponds to one or more entities of the first set of entities comprises comparing entities of the set of entities to entities of the first set of entities, the one or more entities including an intersection between the set of entities to entities of the first set of entities.

Particular implementations of the subject matter described in this specification can be implemented so as to realize one or more of the following advantages. Some implementations provide the advantage of better identifying what part of a website a user wishes to navigate to based on the user's actions. For example, the system may identify that a user has recently searched for cameras, and present the user with links to relevant or interesting cameras that are on the target website. This helps the user get to the relevant product quickly rather than having to search the target site again. The solution can be applied to general queries such as for games and movies as well as for navigational queries. In addition, trending information may be used to provide information about products or topics that are interesting to a wide range of users, and thus may be interesting to the particular user performing the search. This trending data can be shown for a given site or entity based on data about other users' activity (gathered with user permission or mined from public sources), including what people are buying, talking about, sharing, and interacting with in other ways. For example, trending entities can apply across websites, such as identifying that “Halloween” is popular right now based on search data. Trends and other data such as purchases can also be based on location. For example, the system may identify that people in a given area are not buying winter coats and therefore not recommend these products to users from that area, even though the products are trending elsewhere.

Some implementations provide a personalized view of any given website based on, for example, your interests and who you are. For example, a user might particularly like a particular professional football team. The present solution may provide the latest information about the team in response to a general query about “football,” as well as highlighting particular players in the case you have shown that you are a fan of those particular players. In another example, the solution might identify that a user is a developer and present the user with links to more technical information about a given site.

The present solution may also present relevant social activity in the search results. For example, a user's friend may share a review about a particular model of camera. When the user later searches for a camera, the system may present them with a search result for the model of camera annotated with the friend's review.

The present solution may also increase user satisfaction with the target websites by improving the relevance of the presented results and taking the user to the location on the site they want to go. Presently, users tend to do navigational searches and go directly to the website in question. For example, a user might search for the name of a local sporting goods store, which does not have any data about the user since typically the user just searches and goes into the store. In such a case the front page of the store is static and includes no personalization after the click from the search results. In a case where the user has recently been camping, the solution could present the user with direct links to tents, water bottles and other camping related items.

Other features, aspects, and advantages of the subject matter will become apparent from following description, drawings, and claims.

### BRIEF DESCRIPTION OF THE DRAWINGS

FIG. 1 is a block diagram of an example environment in which a search system provides search services.

FIG. 2 depicts an example search results page including recommended content.

FIG. 3A depicts an example search results page including recommended content for a logged-in user.

FIG. 3B depicts an example search results page including recommended content for another logged-in user.

FIG. 4 is a flowchart of an example process for providing recommended content in search results.

Like reference numbers and designations in the various drawings indicate like elements.

### DETAILED DESCRIPTION

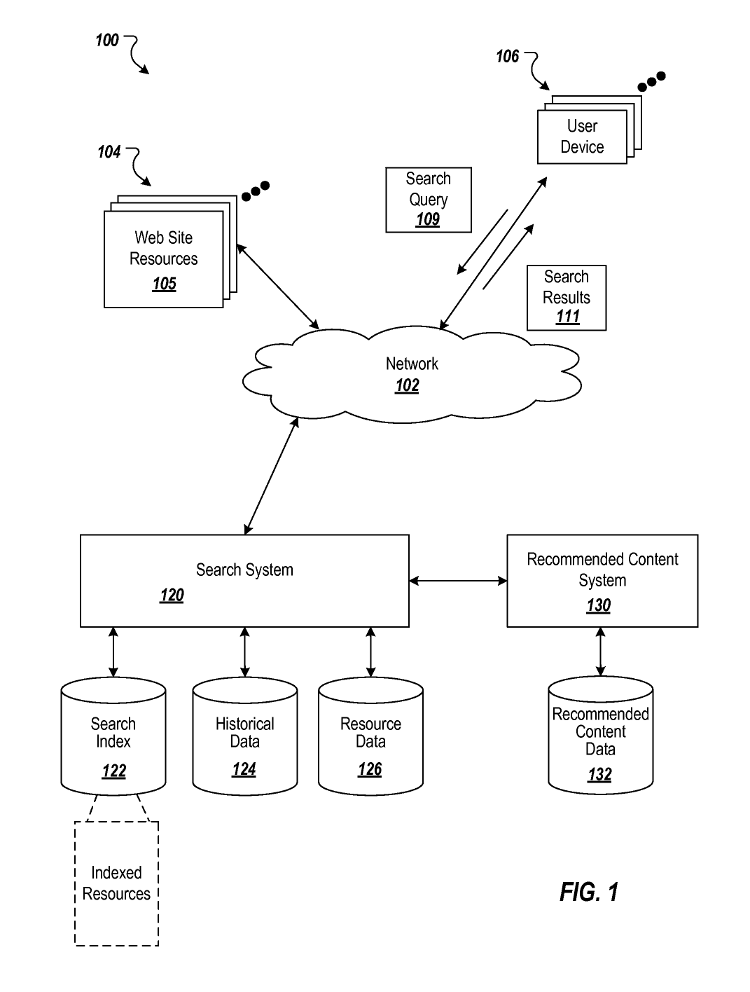

FIG. 1 is a block diagram of an example environment 100 in which a search system 120 provides search services. The example environment 100 includes a network 102, e.g., a local area network (LAN), wide area network (WAN), the Internet, or a combination thereof, connects web sites 104, user devices 106, and the search system 120. In some examples, the network 102 can be accessed over a wired and/or a wireless communications link. For example, mobile computing devices, such as smartphones can utilize a cellular network to access the network. The environment 100 may include millions of web sites 104 and user devices 106.

In some examples, a web site 104 is provided as one or more resources 105 associated with a domain name and hosted by one or more servers. An example web site is a collection of web pages formatted in hypertext markup language (HTML) that can contain text, images, multimedia content, and programming elements, e.g., scripts. Each web site 104 is maintained by a publisher, e.g., an entity that manages and/or owns the web site.

In some examples, a resource 105 is data provided over the network 102 and that is associated with a resource address, e.g., a uniform resource locator (URL). In some examples, resources 105 that can be provided by a web site 104 include HTML pages, word processing documents, and portable document format (PDF) documents, images, video, and feed sources, among other appropriate digital content. The resources 105 can include content, e.g., words, phrases, images and sounds and may include embedded information, e.g., meta information and hyperlinks, and/or embedded instructions, e.g., scripts.

In some examples, a user device 106 is an electronic device that is under control of a user and is capable of requesting and receiving resources 105 over the network 102. Example user devices 106 include personal computers, mobile computing devices, e.g., smartphones and/or tablet computing devices that can send and receive data over the network 102. As used throughout this document, the term mobile computing device (“mobile device”) refers to a user device that is configured to communicate over a mobile communications network. A smartphone, e.g., a phone that is enabled to communicate over the Internet, is an example of a mobile device. A user device 106 typically includes a user application, e.g., a web browser, to facilitate the sending and receiving of data over the network 102.

In some examples, to facilitate searching of resources 105, the search system 120 identifies the resources 105 by crawling and indexing the resources 105 provided on web sites 104. Data about the resources 105 can be indexed based on the resource to which the data corresponds. The indexed and, optionally, cached copies of the resources 105 are stored in a search index 122.

The user devices 106 submit search queries 109 to the search system 120. In response, the search system 120 accesses the search index 122 to identify resources 105 that are relevant to, e.g., have at least a minimum specified relevance score for, the search query 109. The search system 120 identifies the resources 105, generates search results 111 that identify the resources 105, and returns the search results 111 to the user devices 106. A search result 111 is data generated by the search system 120 that identifies a resource 105 that is responsive to a particular search query, and includes a link to the resource 105. An example search result 111 can include a web page title, a snippet of text or a portion of an image extracted from the web page, and the URL of the web page. In some examples, data provided in the search results 111 can be retrieved from a resource data store 126. For example, the search system 120 can provide a search results page that displays the search results 111, where the search results page can be populated with information, e.g., a web page title, a snippet of text or a portion of an image extracted from the web page, that is provided from the resource data store 126.

In some examples, data for the search queries 109 submitted during user sessions are stored in a data store, such as the historical data store 124. For example, the search system 110 can store received search queries in the historical data store 124.

In some examples, selection data specifying actions taken in response to search results 111 provided in response to each search query 109 are also stored in the historical data store 124, for example, by the search system 120. These actions can include whether a search result 111 was selected (e.g., clicked or hovered over with a pointer). The selection data can also include, for each selection of a search result 111, data identifying the search query 109 for which the search result 111 was provided.

In accordance with implementations of the present disclosure, the example environment 100 also includes a recommended content system 130 communicably coupled to the search system 120 (e.g., directly coupled or coupled over a network such as network 102). In some examples, the search system 120 can interact with the recommended content system 130 to provide recommended content specific to the user that submitted the search query 109. In some examples, the recommended content system 130 can provide recommended content data within the search results 111 based on data stored in a recommended content data store 132. In some examples, the recommended content data store 132 may include information specific to the user that submitted the search query 109. In some examples, the recommended content data store 132 may include this data for many different users. In some examples, the recommended content data store 132 may be a dedicated data store specific to the user submitting the search query 109. In some examples, the recommended content data store 132 may include trending information that is agnostic to the user that submitted the search query 109.

In some implementations, the recommended content system 130 may receive the search query and an identification of the user from the search system 120. For example, the user can be logged into a search service that provides the search system 120. In response, the recommended content system 130 can provide a set of recommended content to the search system 120. In some examples, the set of recommended content is customized based on data associated with the identified user from the recommended content data 132. In some examples, the recommended content data 132 can include information related to trending information based on the search query 109.

In some implementations, the recommended content system 130 can provide a set of recommended content that can be displayed in the search results 111. In some examples, the search system 120 retrieves digital content based on the set of recommended content. In some examples, the search system 120 generates one or more search result web pages based on the retrieved digital content. In this manner, the search results 111, e.g., provided in a search results web page, can be tailored to the user that submitted the search query 109.

Implementations of the present disclosure are generally directed to displaying recommended content within search results provided on search pages. In some implementations, the recommended content can be provided as user-specific content and/or trending content. For example, recommended content can be provided based on user interests and/or preferences. As another example, recommended content can be provided based on user-agnostic trends. In accordance with implementations of the present disclosure, useful search results can be provided by providing content that is relevant to the user. Further, the content may include trending items that are currently popular or noteworthy, and can be consequently of interest to the user.

Example implementations for providing recommended content according to the present disclosure are presented herein. In some examples, systems that provide recommended content within search results will generally include a search index that indexes a plurality of network-available resources, e.g., web sites each made up of a plurality of web pages. In some examples, resources such as web pages may be associated with one or more entities. In some examples, an “entity” is an entry in a knowledge graph used to connect related pieces of content. For example, a page contained in an online retailer web site that allows a user to purchase an item, e.g., a tent, may be associated with an item-specific entity, e.g., the “tent” entity, while a page that allows the user to purchase a nail gun may be associated with a “nail gun” entity. Further, a page may be associated with one or more category entities representing a larger class of entities. For example, the tent page discussed above may be associated with both the “tent” entity and the “camping” category entity, while the nail gun page may be associated with the “nail gun” entity and the “home improvement” category entity.

In some implementations, each resource includes a set of entities associated therewith. In some examples, the set of entities can be provided from a resource entity identification service. In some examples, the set of entities is a non-empty set and includes entities that can be found within the resource. For example, the online retailer web site can offer a plurality of items for sale, each item being an entity. Consequently, the set of entities associated with the web site can include item entities and category entities.

In some implementations, each user of a search service, e.g., the search system 120 of FIG. 1, can have a set of entities associated therewith. In some examples, the set of entities can be provided from a user entity identification service. In some examples, the set of entities is a non-empty set and includes entities that have been identified as potentially relevant to the particular user. In some examples, entities can be provided for the particular user based on user-defined interests, user-submitted search queries, and social networking data, among other potential data channels.

For example, a user may publicly provide data recommending particular items, e.g., skis, to other users, publicly indicating occurrence of an event, e.g., a 4^{th} of July barbeque, publicly provide profile information regarding hobbies and interests, and/or can publicly request information regarding specific entities, e.g., items. In some examples, the set of entities associated with the user can include entities provided from the public data. For example, if the user recommends skis to other users, the set of entities can include a category entity of skis and/or an item entity specific to a particular brand/make of ski. As another example, if the user is planning a barbecue, the set of entities can include entities associated with barbecue items, such as grills. As another example, if a hobby of the user includes camping, the set of entities can include entities associated with camping, such as tents and sleeping bags.

In some implementations, each entity in the set of entities can include a relevancy score associated therewith. In some examples, a relevancy score indicates a relative importance of a particular entity. For example, an entity that is determined to be highly relevant to a particular user can have a relevancy score that is higher than an entity that is determined to be less relevant to the particular user.

In some implementations, one or more sets of trending entities can be provided. In some examples, the set of trending entities can be provided from a trending entity identification service. In some examples, trending entities can include entities that are being purchased, e.g., from online retailers, being discussed, e.g., in posts on social networking services, being shared, and the like, more often than other entities.

In some examples, a set of trending entities can include globally trending entities. In some examples, globally trending entities can include entities that are non-user and non-resource specific entities that have been determined to be popular. For example, it can be determined that the entity “Halloween” is particularly popular, is trending, within a time period. The entity “Halloween” is resource and user agnostic.

In some examples, a set of trending entities can include resource-specific trending entities. In some examples, resource-specific entities can include non-user specific entities of a particular resource that have been determined to be popular. For example, users can be purchasing a particular item from the online retailer at a particularly high rate. Consequently, the entity, or entities, associated with the particular item can be trending for the online retailer, while the same entity, or entities, associated with the particular item are not trending for another online retailer.

In some implementations, each entity in the set of trending entities can include a relevancy score associated therewith. In some examples, a relevancy score indicates a relative importance of a particular entity. For example, an entity that is determined to be highly trending can have a relevancy score that is higher than an entity that is determined to be less trending.

In some examples, entities provided in one or more of the above-discussed sets of entities can be identified based on location. For example, the entity “winter coats” may be a trending entity in a location, but not trending in another location. In some examples, such entities can be identified as trending based on a location of the user submitting a search query and/or a location of, for example, a retailer selling an item associated with the entity.

In some implementations, a search query can be received from a user. Search results can be provided based on the search query and can include one or more web sites, for example. In some examples, one or more sets of entities for display in a search result associated with the web site are retrieved. In some examples, the set of entities associated with the pages can be compared to a set of entities that the user is interested in. In this manner, a set of recommended content can be provided. For example, entities that are included in both the set of entities associated with the pages and the set of entities that the user is interested in are included in the set of recommended content. In some examples, the set of recommended content can also include trending entities. In some examples, trending entities can include entities that can be determined to be of interest to users of the search system globally and/or to users to which the user is connected socially.

In accordance with implementations of the present disclosure, recommended content within the set of recommended content is provided for display to the user. In some implementations, recommended content is displayed in-line with the search results. In some implementations, the recommended content may be presented within “hover cards” which are displayed when the user hovers over, e.g., places a pointer over a specific location on the search results page for a certain amount of time.

In some examples, the set of recommended content can be provided from a super-set of recommended content. For example, the super-set of recommended content can include too much content to be displayed with search results. Consequently, recommended content can be identified from the super-set of recommended content to populate the set of recommended content. In some examples, the recommended content can be identified based on relevancy scores. For example, the recommended content associated with the highest X relevancy scores can be identified for inclusion in the set of recommended content. In some examples, the recommended content can be randomly identified for inclusion in the set of recommended content.

In some examples, the set of recommended content can be provided from a set of user-specific recommended content and a set of trending recommended content. In this manner, the set of recommended content includes a mixture of user-specific recommended content and trending recommended content. For example, the set of recommended content can be configured to include X number of user-specific recommended content and Y number of trending recommended content. In some examples, the user-specific recommended content can be identified from the set of user-specific recommended content based on relevancy scores. For example, the user-specific recommended content associated with the highest X relevancy scores can be identified for inclusion in the set of recommended content. In some examples, the trending recommended content can be identified from the set of trending recommended content based on relevancy scores. For example, the trending recommended content associated with the highest Y relevancy scores can be identified for inclusion in the set of recommended content.

Implementations of the present disclosure are discussed in further detail herein with reference to an example context. The example context includes search results associated with a retail store that sells goods. It is contemplated, however, that implementations of the present disclosure can be provided in other contexts. For example, implementations of the present disclosure can be provided with search results associated with an organization that sells goods and/or services. As another example, implementations of the present disclosure can be provided with search results associated with goods, services, locations and other appropriate subject matter.

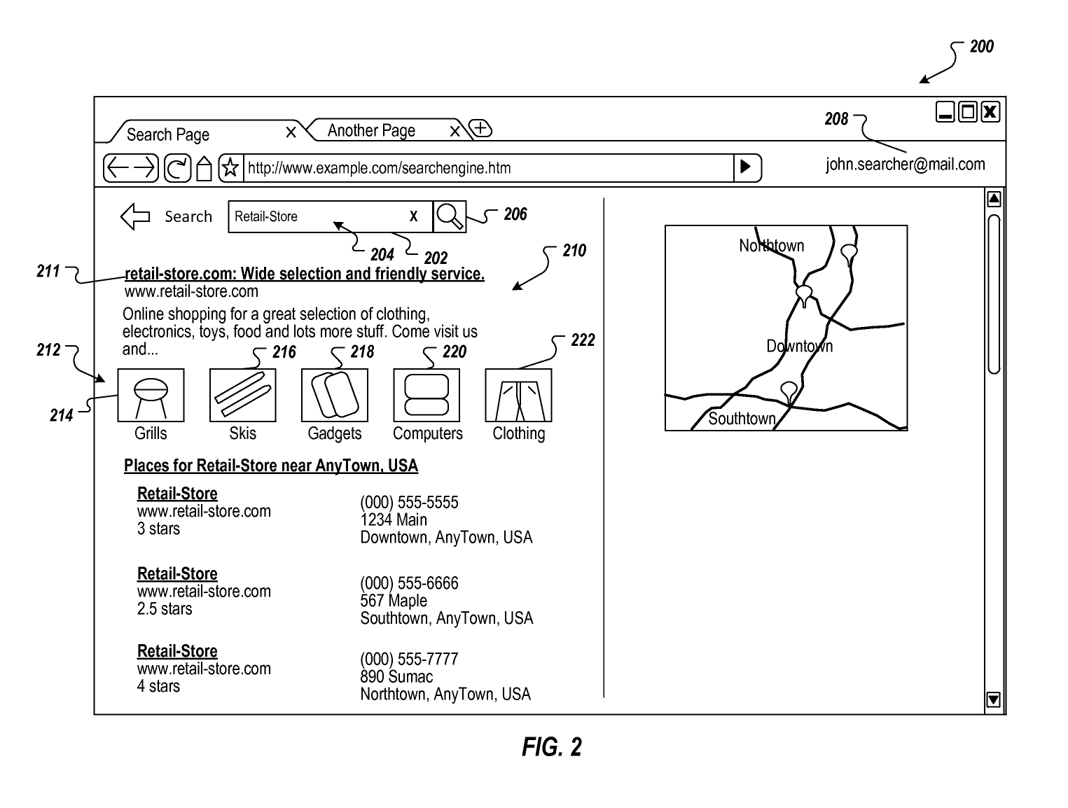

FIG. 2 depicts an example search results page 200 including recommended content. Although the example search results page 200 is depicted inside a web browser, this is for context only and is not intended to limit the scope of the present disclosure to any one web browser or even to implementations involving serving a web page. The example search results page 200 includes a search box 202. In some implementations, the search box 202 may be a text box specified using hypertext markup language (HTML). In implementations, the search box 202 may be a custom component specified by another suitable web development language such as Javascript. The illustrated search box 202 includes a search query 204. In the depicted example, the search query includes “Retail-Store,” which can include the name of a retail store. In some examples, the search query 204 may be entered by a user. In some examples, the search query 204 may be programmatically received through an application programmer interface (API) or other suitable means. The illustrated search box 202 is also associated with a search button 206. In some examples, a user may perform a search on the search query 204 by activating, e.g., clicking on, the search button 206. This activation may be performed by any appropriate mechanism such as clicking the search button 206 with a pointing device (e.g., a mouse) or pressing a key or combination of keys on a keyboard. In some examples, the search query 204 can be automatically submitted as it is being entered.

The illustrated search results page 200 also includes first user information 208. In the illustrated example, the first user information 208 indicates that the user “john.searcher@mail.com” is currently logged in. In accordance with implementations of the present disclosure, recommended content provided within search results will be, at least in part, associated with the user john.searcher@mail.com. In some implementations, the search results page 200 might not include an indication of the current user, but the search query 204 may still be processed according to the current user.

The illustrated search results page 200 also includes a search results pane 210 including one or more search results. In some implementations, the search results pane 210 is an HTML frame segregating the search results from other panes of the search results page 200. In some implementations, the search results pane 210 is provided as a consecutive list of search results.

The illustrated search results pane 210 includes search result 211. In some implementations, the search result 211 may include a hyperlinked description or page title for the web site associated with the search result 211. The search result 211 may also include a text version of the uniform resource locator (URL) associated with the search result 211. In some cases, the search result 211 may be associated with active content, such as a “hover card” containing additional information about the search result that appears when the user hovers over it with a pointing device such as a mouse. The example search result 211 depicted in FIG. 2 is a “navigational search result” provided because the search query 204 has been determined to have a navigational intent. This means that the search query 204 indicates that the user wishes to navigate to a particular web site, in this case the web site associated with “Retail-Store.” In some implementations, the search result 211 may be a different type of search result indicating a different user intent.

The illustrated search result 211 includes recommended content 212. The recommended content 212 can include digital content that is associated with links to pages included in the web site associated with the search result 211. For example, the recommended content 212 can include digital content associated with a link to an overview page, a contact page, a products page, or to any other page it has been determined users and/or the particular user may be interested in. In this manner, the search result 211 is made more useful for the user by including direct links to pages that the user is more likely to visit, thereby saving the user the trouble of navigating through the web site to find a particular page.

In some implementations, inclusion of the recommended content 212 can be triggered in response to determining that the search query 204 has a navigational intent. In some examples, the navigational intent can imply that the user seeks to navigate to the particular web site that is represented by the search result 211. Consequently, the user may be looking for a specific web page or web pages of the web site. By providing the recommended content 212, the user is provided a channel to more quickly navigate to a web page or web pages of interest within the web site.

The depicted search result 211 includes a set of recommended content 212 that is at least partially customized to the current user (john.searcher@mail.com). In the depicted example, the recommended content 212 includes digital content of thumbnail images and text, which can be associated with links to pages. In the depicted example, the recommended content are each associated with a category entity. The depicted category entities include a grills category 214, a skis category 216, a gadgets category 218, a computers category 220, and a clothing category 222. These category entities may be selected based on the previously observed activity or other information known about the user john.searcher@mail.com.

In some examples, a set of entities associated with the web site “www.retail-store.com” of the search result 211 can be received. The set of entities can include the example category entities of: food, medication, clothing, basketballs, skis, sleeping bags, gadgets, computers, and cleaning among many others. A set of entities associated with the user “john.searcher@mail.com” can be received and can include the example category entities of: grills, skis and clothing among many others. A set of trending entities can be received and can include the example category entities of: gadgets and computers among many others.

In some examples, the set of entities associated with the web site can be compared to the set of entities associated with the user and the set of trending entities to identify recommended content to display with the search result 211. In the instant example, it can be determined that the category entities grills, skis and clothing intersect between the set of entities associated with the web site and the set of entities associated with the user, and that the category entities gadgets and computers intersect between the set of entities associated with the web site and the set of trending entities. Consequently, a set of recommended content can be populated with the category entities grills, skis, gadgets, computers and clothing. In some examples, the order of display of digital content can be defined to provide a mixture of user-specific recommended content and trending recommended content. For example, the first X digital content can depict user-specific recommended content and the next Y digital content can depict trending recommended content.

The search results page 200 can be generated based on the set of recommended content to provide digital content, e.g., thumbnail images and text, associated with the category entities grills, skis, gadgets, computers and clothing, as depicted in FIG. 2. In this manner, the user is quickly able to identify categories of the web site “www.retail-store.com” that might be of interest and can quickly navigate to a web page associated with a particular category, e.g., by clicking on a thumbnail image, without having to search through the web site to locate the web page.

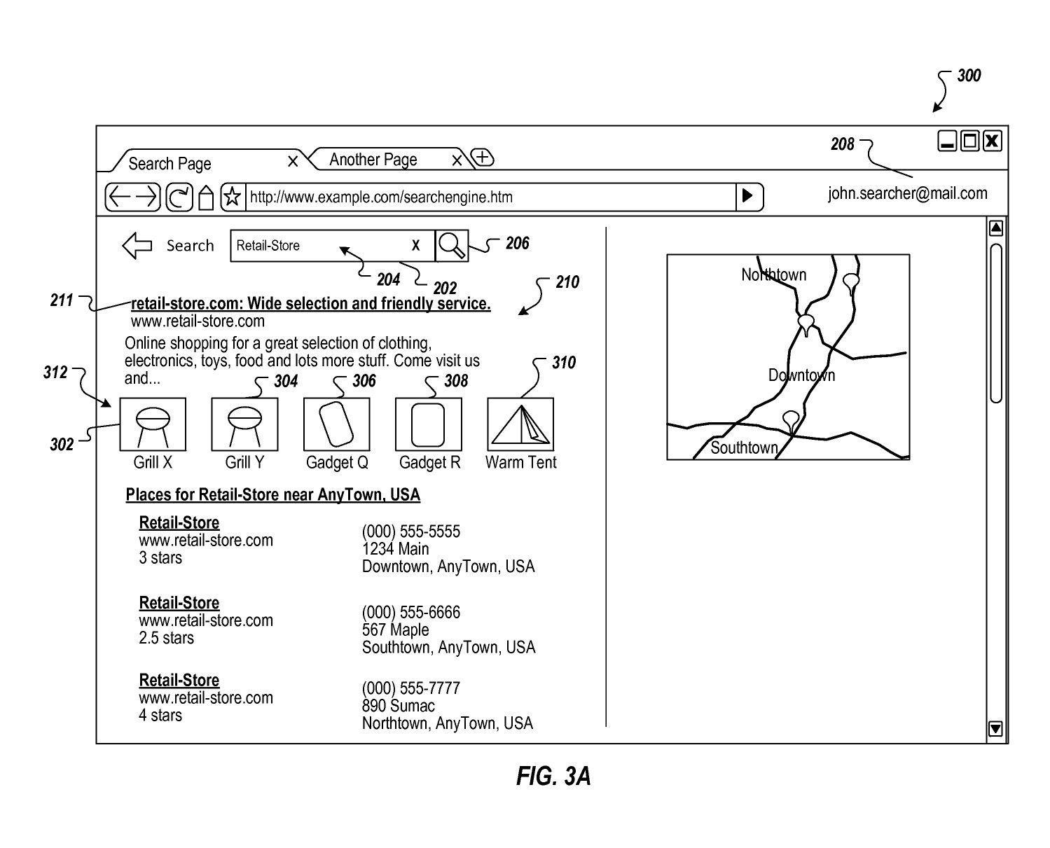

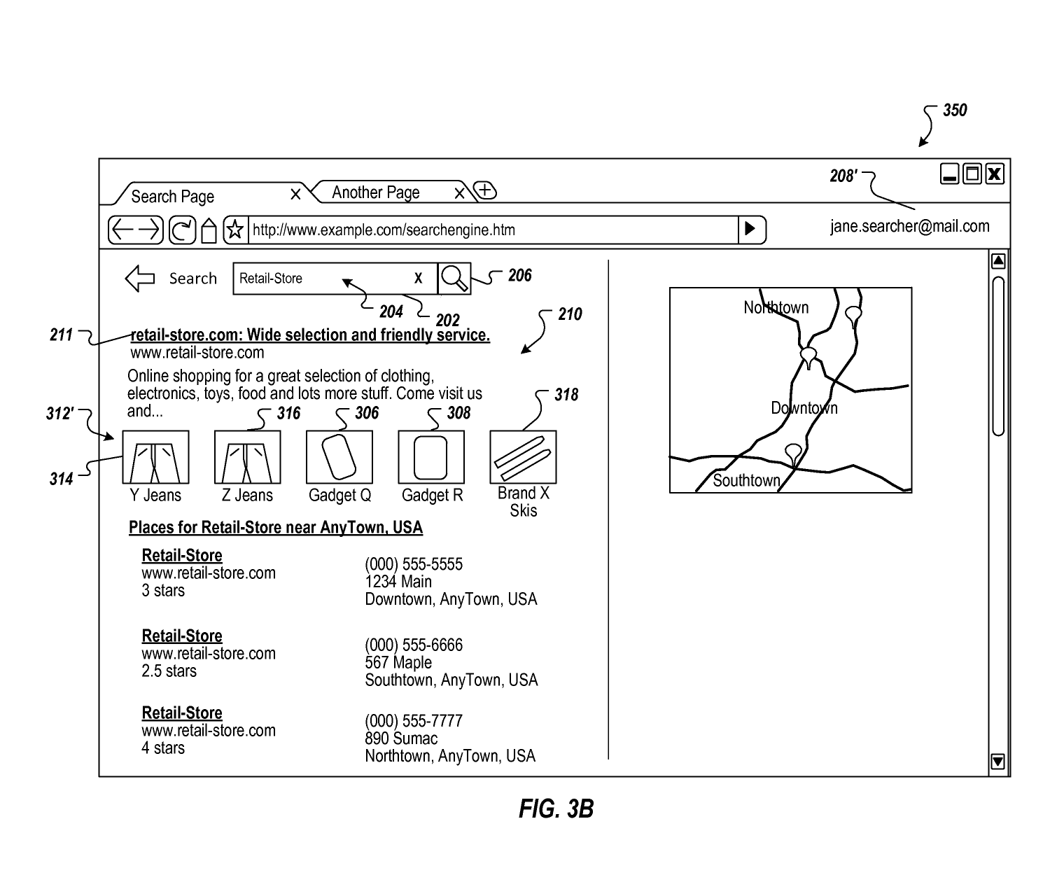

FIG. 3A depicts an example search results page 300 including recommended content for a logged-in user. Although the example search results page 300 is depicted inside a web browser, this is for context only and is not intended to limit the scope of the present disclosure to any one web browser or even to implementations involving serving a web page. The illustrated search results page 300 includes the search box 202, the search query 204, the search button 206, the user information 208, the search results pane 210, and the search result 211. These components have already been described relative to FIG. 2, and in the interest of brevity will not be described again here.

The illustrated search result 211 includes a set of recommended content 312 that is at least partially customized to the current user (john.searcher@mail.com). In the depicted example, the recommended content 312 includes digital content of thumbnail images and text that can be associated with links to pages. In the example of FIG. 3, recommended content 312 represents pages related to specific products, as opposed to broader categories of product. The depicted product entities include a first grill product 302, a second grill product 304, a first trending gadget product 306, a second trending gadget product 308, and a tent product 310.

In some examples, a set of entities associated with the web site “www.retail-store.com” of the search result 211 can be received. The set of entities can include the example category entities of: food, medication, clothing, basketballs, skis, sleeping bags, gadgets, computers, and cleaning among many others. The set of entities can include the example item entities of: X Jeans, Y Jeans, Z Jeans, Grill X, Grill Y, Grill Z, Gadget Q, Gadget R, Gadget S, Warm Tent, Cold Tent, Brand A Skis and Brand X Skis, among many others, where each item entity is specific to an item sold by Retail-Store. A set of entities associated with the user “john.searcher@mail.com” can be received and can include the example item entities of: Grill X, Grill Y and Warm Tent among many others. A set of trending entities can be received and can include the example item entities of: Gadget Q, Gadget R and Gadget S among many others.

In some examples, the set of entities associated with the web site can be compared to the set of entities associated with the user and the set of trending entities to identify recommended content to display with the search result 211. In the instant example, it can be determined that the item entities Grill X, Grill Y and Warm Tent intersect between the set of entities associated with the web site and the set of entities associated with the user, and that the item entities Gadget Q and Gadget R intersect between the set of entities associated with the web site and the set of trending entities. Consequently, a set of recommended content can be populated with the item entities Grill X, Grill Y, Gadget Q, Gadget R and Warm Tent.

The search results page 300 can be generated based on the set of recommended content to provide digital content, e.g., thumbnail images and text, associated with the item entities Grill X, Grill Y, Gadget Q, Gadget R and Warm Tent, as depicted in FIG. 3A. In this manner, the user is quickly able to identify categories of the web site “www.retail-store.com” that might be of interest and can quickly navigate to a web page associated with a particular category, e.g., by clicking on a thumbnail image, without having to search through the web site to locate the web page.

FIG. 3B depicts an example search results page 350 including recommended content for another logged-in user. Although the example search results page 350 is depicted inside a web browser, this is for context only and is not intended to limit the scope of the present disclosure to any one web browser or even to implementations involving serving a web page. The illustrated search results page 350 includes the search box 202, the search query 204, the search button 206, the search results pane 210, and the search result 211. These components have already been described relative to FIG. 2, and in the interest of brevity will not be described again here.

The illustrated search result includes a set of recommended content 312′ that is at least partially customized to the current user 208′, “jane.searcher@mail.com” in the depicted example. Note that, in the illustrated example of FIG. 3B, the current user 208′ is different than the user 208 in FIG. 3A. Accordingly, the recommended content 312′ is customized for jane.searcher@mail.com rather than for john.searcher@mail.com in FIG. 3A. In the example of FIG. 3B, the recommended content 312′ includes a first clothing product 314, a second clothing product 316, the first trending gadget product 306, the second trending gadget product 308, and a ski product 318.

In some examples, a set of entities associated with the web site “www.retail-store.com” of the search result 211 can be received. The set of entities can include the example category entities of: food, medication, clothing, basketballs, skis, sleeping bags, gadgets, computers, and cleaning among many others. The set of entities can include the example item entities of: X Jeans, Y Jeans, Z Jeans, Grill X, Grill Y, Grill Z, Gadget Q, Gadget R, Gadget S, Warm Tent, Cold Tent, Brand A Skis and Brand X Skis, among many others, where each item entity is specific to an item sold by Retail-Store. A set of entities associated with the user “jane.searcher@mail.com” can be received and can include the example item entities of: Y Jeans, Z Jeans and Brand X Skis among many others. A set of trending entities can be received and can include the example item entities of: Gadget Q, Gadget R and Gadget S among many others.

In some examples, the set of entities associated with the web site can be compared to the set of entities associated with the user and the set of trending entities to identify recommended content to display with the search result 211. In the instant example, it can be determined that the item entities Y Jeans, Z Jeans and Brand X Skis intersect between the set of entities associated with the web site and the set of entities associated with the user, and that the item entities Gadget Q and Gadget R intersect between the set of entities associated with the web site and the set of trending entities. Consequently, a set of recommended content can be populated with the item entities Y Jeans, Z Jeans, Gadget Q, Gadget R and Brand X Skis.

The search results page 350 can be generated based on the set of recommended content to provide digital content, e.g., thumbnail images and text, associated with the item entities Y Jeans, Z Jeans, Gadget Q, Gadget R and Brand X Skis, as depicted in FIG. 3B. In this manner, the user is quickly able to identify categories of the web site “www.retail-store.com” that might be of interest and can quickly navigate to a web page associated with a particular category, e.g., by clicking on a thumbnail image, without having to search through the web site to locate the web page.

FIGS. 2, 3A and 3B are representative of the example context discussed above. As also noted above, implementations of the present disclosure can be provided in other contexts. For example, a search query can include the term “movies,” and responsive search results can include web sites associated with movie theaters. The search results can also be provided with recommended content based on an intersection between entities associated with the web sites and entities that are potentially of interest to the user that submitted the search query. In the example context of a movie theater web site, example recommended content can be representative of categories of movies that are of interest to the particular user and/or movies that are of interest to the particular user. As another example, a search query can include the term “movie reviews,” and responsive search results can include a web site that provides movie reviews. The search result can also be provided with recommended content based on an intersection between entities associated with the web site and entities that are potentially of interest to the user that submitted the search query. In the example context of a movie review web site, example recommended content can be representative of categories of movies that are of interest to the particular user and/or movies that are of interest to the particular user.

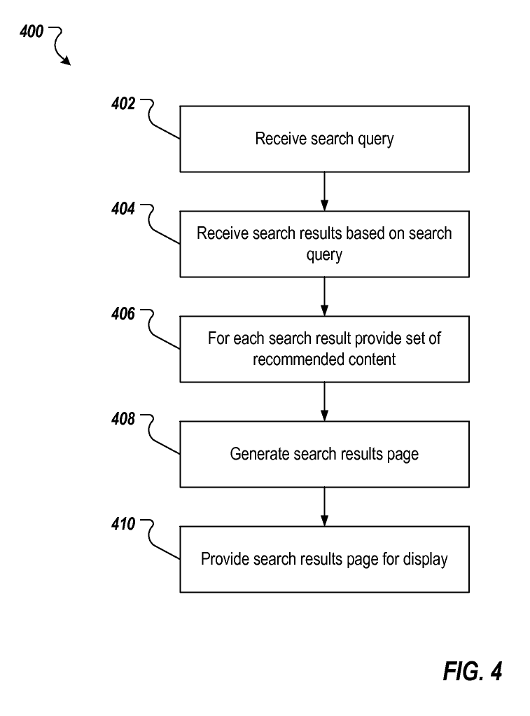

FIG. 4 is a flowchart of an example process 400 for providing recommended content in search results. In some examples, the process 400 can be provided using one or more computer-executable programs that are executed using one or more computing devices. For example, process 400 can be provided, for example, by the example environment.

A search query is received (402). For example, the search query can be received by the search system 120 of FIG. 1. Search results based on the search query are received (404). For example, the search system 120 can receive search results that are responsive to the search query. For each search result, a set of recommended content is provided (406). In some examples, the search system 120 can receive the set of recommended content from the recommended content system 130. In some examples, the set of recommended content is provided based on comparing a set of entities associated with one or more resources underlying the search result with a set of entities associated with the user that provided the search query. In some examples, the set of recommended content is provided based on comparing the set of entities associated with one or more resources underlying the search result with a set of trending entities. In some examples, the recommended content system 130 performs set comparisons to provide the set of recommended content. In some examples, the set of recommended content is provided in response to determining that the search query has a navigational intent.

A search results page is generated (408). For example, the search system 120 can generate a search results page. In some examples, the search system receives the set of recommended content from the recommended content system 130. In some examples, the search system 130 identifies digital content representative of recommended content in the set of recommended content. In some examples, the search system 120 populates a search results document with URLs associated with the digital content. The search results page is provided for display to the user (410). For example, the search system 120 can transmit the search results document to a computing device of the user, which search results document can be processed to display the search results page to the user, e.g., within a browser window.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer can include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method executed by one or more processors, the method comprising:
receiving, by the one or more processors, a search query, the search query being received from a first user of a computer-implemented search service;
receiving, by the one or more processors, a search result that is responsive to the search query, the search result being representative of one or more resources;
receiving, by the one or more processors, a set of entities associated with the one or more resources;
receiving a first set of entities associated with the first user, each entity in the first set of entities having been determined to be of interest to the first user;
determining that one or more entities of the set of entities corresponds to one or more entities of the first set of entities and, in response, providing a first set of recommended content, the first set of recommended content comprising the one or more entities of the set of entities;
providing a first search results page, the first search results page comprising the search result and digital content representative of recommended content provided in the first set of recommended content, the digital content providing a link to a resource of the one or more resources; and
transmitting the first search results page for display to the first user.

2. The computer-implemented method of claim 1, further comprising:
receiving a set of trending entities, each entity in the set of trending entities having been determined to be of interest to users; and
determining that one or more entities of the set of entities corresponds to one or more entities of the set of trending entities and, in response, including the one or more entities of the set of trending entities in the first set of recommended content.

3. The computer-implemented method of claim 1, further comprising:
receiving, by the one or more processors, the search query, the search query being received from a second user of a computer-implemented search service;
receiving, by the one or more processors, the search result that is responsive to the search query;
receiving, by the one or more processors, the set of entities associated with the one or more resources;
receiving a second set of entities associated with the second user, the second set of entities comprising at least one entity that had been determined to be of interest to the second user;
determining that one or more entities of the set of entities corresponds to one or more entities of the second set of entities and, in response, providing a second set of recommended content, the second set of recommended content including the one or more entities of the second set of entities;
providing a second search results page, the second search results page comprising the search result and digital content representative of recommended content provided in the second set of recommended content, the digital content providing a link to a resource of the one or more resources; and
transmitting the second search results page for display to the second user.

4. The computer-implemented method of claim 1, wherein at least a portion of the recommended content in the first set of recommended content is different than recommended content in the second set of recommended content.

5. The computer-implemented method of claim 1, wherein the digital content is representative of categories of entities.

6. The computer-implemented method of claim 1, further comprising determining that an intent of the first user comprises a navigational intent based on the search query, and in response:
requesting the set of entities associated with the one or more resources, and
requesting the first set of entities associated with the first user.

7. The computer-implemented method of claim 1, further comprising providing the set of recommended content as a sub-set of a super-set of recommended content.

8. The computer-implemented method of claim 7, wherein recommended content of the super-set of recommended content is selectively included in the set of recommended content based on respective relevance scores.

9. The computer-implemented method of claim 1, wherein the digital content comprises thumbnail images and text associated with one or more web pages of a web site, the search result being representative of the web site.

10. The computer-implemented method of claim 1, wherein determining that one or more entities of the set of entities corresponds to one or more entities of the first set of entities comprises comparing entities of the set of entities to entities of the first set of entities, the one or more entities comprising an intersection between the set of entities to entities of the first set of entities.

11. A computer storage medium encoded with a computer program, the program comprising instructions that when executed by data processing apparatus cause the data processing apparatus to perform operations comprising:
receiving a search query, the search query being received from a first user of a computer-implemented search service;
receiving a search result that is responsive to the search query, the search result being representative of one or more resources;
receiving a set of entities associated with the one or more resources;
receiving a first set of entities associated with the first user, each entity in the first set of entities having been determined to be of interest to the first user;
determining that one or more entities of the set of entities corresponds to one or more entities of the first set of entities and, in response, providing a first set of recommended content, the first set of recommended content comprising the one or more entities of the set of entities;
providing a first search results page, the first search results page comprising the search result and digital content representative of recommended content provided in the first set of recommended content, the digital content providing a link to a resource of the one or more resources; and
transmitting the first search results page for display to the first user.

12. The computer storage medium of claim 11, wherein operations further comprise:
receiving a set of trending entities, each entity in the set of trending entities having been determined to be of interest to users; and
determining that one or more entities of the set of entities corresponds to one or more entities of the set of trending entities and, in response, including the one or more entities of the set of trending entities in the first set of recommended content.

13. The computer storage medium of claim 11, wherein operations further comprise:
receiving the search query, the search query being received from a second user of a computer-implemented search service;
receiving the search result that is responsive to the search query;
receiving the set of entities associated with the one or more resources;
receiving a second set of entities associated with the second user, the second set of entities comprising at least one entity that had been determined to be of interest to the second user;
determining that one or more entities of the set of entities corresponds to one or more entities of the second set of entities and, in response, providing a second set of recommended content, the second set of recommended content including the one or more entities of the second set of entities;
providing a second search results page, the second search results page comprising the search result and digital content representative of recommended content provided in the second set of recommended content, the digital content providing a link to a resource of the one or more resources; and
transmitting the second search results page for display to the second user.

14. The computer storage medium of claim 11, wherein at least a portion of the recommended content in the first set of recommended content is different than recommended content in the second set of recommended content.

15. The computer storage medium of claim 11, wherein the digital content is representative of categories of entities.

16. The computer storage medium of claim 11, wherein operations further comprise determining that an intent of the first user comprises a navigational intent based on the search query, and in response:
requesting the set of entities associated with the one or more resources, and
requesting the first set of entities associated with the first user.

17. The computer storage medium of claim 11, wherein operations further comprise providing the set of recommended content as a sub-set of a super-set of recommended content.

18. The computer storage medium of claim 17, wherein recommended content of the super-set of recommended content is selectively included in set of recommended content based on respective relevance scores.

19. The computer storage medium of claim 11, wherein the digital content comprises thumbnail images and text associated with one or more web pages of a web site, the search result being representative of the web site.

20. The computer storage medium of claim 11, wherein determining that one or more entities of the set of entities corresponds to one or more entities of the first set of entities comprises comparing entities of the set of entities to entities of the first set of entities, the one or more entities comprising an intersection between the set of entities to entities of the first set of entities.

21. A system comprising:
a data store for storing content items; and
one or more processors configured to interact with the data store, the one or more processors being further configured to perform operations comprising:
receiving a search query, the search query being received from a first user of a computer-implemented search service;
receiving a search result that is responsive to the search query, the search result being representative of one or more resources;
receiving a set of entities associated with the one or more resources;
receiving a first set of entities associated with the first user, each entity in the first set of entities having been determined to be of interest to the first user;
determining that one or more entities of the set of entities corresponds to one or more entities of the first set of entities and, in response, providing a first set of recommended content, the first set of recommended content comprising the one or more entities of the set of entities;
providing a first search results page, the first search results page comprising the search result and digital content representative of recommended content provided in the first set of recommended content, the digital content providing a link to a resource of the one or more resources; and
transmitting the first search results page for display to the first user.

22. The system of claim 21, wherein operations further comprise:
receiving a set of trending entities, each entity in the set of trending entities having been determined to be of interest to users; and
determining that one or more entities of the set of entities corresponds to one or more entities of the set of trending entities and, in response, including the one or more entities of the set of trending entities in the first set of recommended content.

23. The system of claim 21, wherein operations further comprise:
receiving the search query, the search query being received from a second user of a computer-implemented search service;
receiving the search result that is responsive to the search query;
receiving the set of entities associated with the one or more resources;
receiving a second set of entities associated with the second user, the second set of entities comprising at least one entity that had been determined to be of interest to the second user;
determining that one or more entities of the set of entities corresponds to one or more entities of the second set of entities and, in response, providing a second set of recommended content, the second set of recommended content including the one or more entities of the second set of entities;
providing a second search results page, the second search results page comprising the search result and digital content representative of recommended content provided in the second set of recommended content, the digital content providing a link to a resource of the one or more resources; and
transmitting the second search results page for display to the second user.

24. The system of claim 21, wherein at least a portion of the recommended content in the first set of recommended content is different than recommended content in the second set of recommended content.

25. The system of claim 21, wherein the digital content is representative of categories of entities.

26. The system of claim 21, wherein operations further comprise determining that an intent of the first user comprises a navigational intent based on the search query, and in response:
requesting the set of entities associated with the one or more resources, and
requesting the first set of entities associated with the first user.

27. The system of claim 21, wherein operations further comprise providing the set of recommended content as a sub-set of a super-set of recommended content.

28. The system of claim 27, wherein recommended content of the super-set of recommended content is selectively included in set of recommended content based on respective relevance scores.

29. The system of claim 21, wherein the digital content comprises thumbnail images and text associated with one or more web pages of a web site, the search result being representative of the web site.

30. The system of claim 21, wherein determining that one or more entities of the set of entities corresponds to one or more entities of the first set of entities comprises comparing entities of the set of entities to entities of the first set of entities, the one or more entities comprising an intersection between the set of entities to entities of the first set of entities.
